(19) United States
(12) Patent Application Publication
(10) Pub. No.: US 2006/0243369 A1
(43) Pub. Date: Nov. 2, 2006

(54) Method for repairing water-retaining structures using a multi-layer composite barrier system

(76) Inventors: William F. Kepler, Golden, CO (US); Kurt F. von Fay, Morrison, CO (US)

Correspondence Address: Division of General Law;Office of the Solicitor, U.S. Department of the Interior, 1849 C Street NW, MS 6530, Washington, DC, 20240, US

(21) Appl. No.: 10/252,765

(22) Filed: Sep. 24, 2002

(51) Int. Cl. B29C 73/00

(52) U.S. Cl. 156/94

(57) ABSTRACT

A method is provided for repairing water retaining concrete structures, such as dams or canals. The method includes the application of a water impervious bituminous sealing layer over a selected area of the existing concrete structure to be sealed. A geotextile layer is applied over the bituminous sealing and forms a bond with this layer as well as to an outer layer of concrete. The latter protects the bituminous layer from weathering.

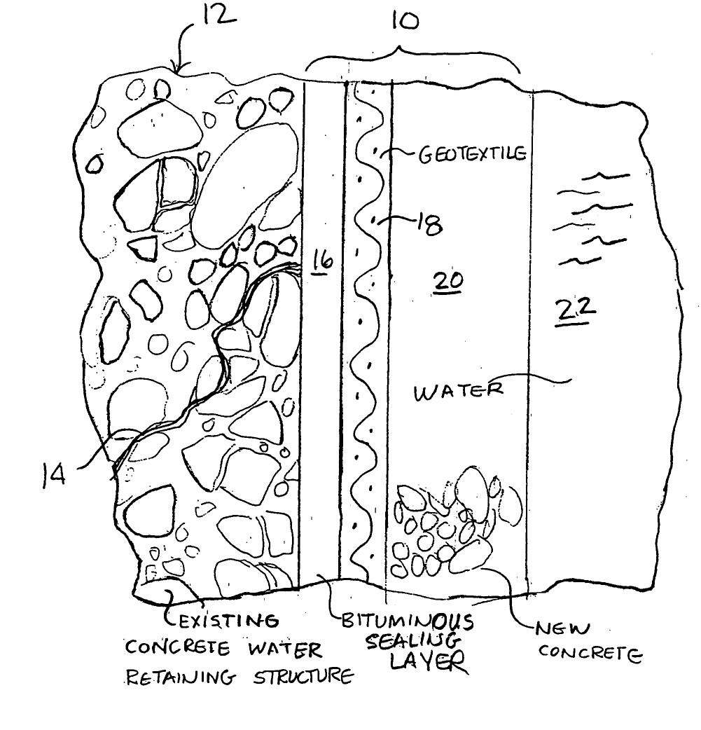

### FIELD OF THE INVENTION

The present invention relates to a method for repairing concrete water-retaining structures, such as dams and canals, which employs a multi-layer composite system.

### BACKGROUND OF THE INVENTION

Water retaining structures such as dams, canals and the like often develop surface cracks from stresses caused by environmental conditions. These cracks must be repaired in a manner that prevents leakage and maintains the structural integrity of the original structure. The current method for repairing concrete water-retaining structures involves the mechanical bonding of a membrane to the existing structure. This method is expensive, prone to leaking, and does not perform well for long periods of time due to weathering. While the membrane initially seals the existing structure, the use of a mechanically bonded membrane does not provide a long-term solution to the problem of leakage.

### SUMMARY OF THE INVENTION

The invention is concerned with a method for repairing dams and other concrete structures, which employs a multiple layer barrier system that is inexpensive, easy to apply, and durable. The invention can be used for large scale lining of existing concrete,structures such as dams and canals so as to prevent leaks over large areas. The invention is an improvement over traditional or conventional methods, which, as noted above, typically use mechanically bonded membranes, particularly with respect to durability of the concrete repairs.

In accordance with the invention a method for repairing water-retaining structures including an existing concrete outer surface which, in use, is in contact with the water to be retained, the method comprising:

applying water impervious bituminous sealing layer over a portion of the concrete surface to form a watertight sealing of the existing concrete layer;

applying a geosynthetic material to the water impervious bituminous sealing layer; and

applying a layer of concrete to the geosynthetic material such that said geosynthetic material provides a bond between said concrete layer and said bituminous sealing layer and said concrete layer provides a hard, durable outside protective layer for preventing weathering of said bituminous layer.

Further features and advantages of the present invention will be set forth in, or apparent from, the detailed description of preferred embodiments thereof which follows.

### BRIEF DESCRIPTION OF THE DRAWINGS

The single FIGURE in the drawings is a cross section view of a multi-layer composite barrier system used in the method of the present invention for repairing water-retaining structures, the barrier system being constructed in accordance with a preferred embodiment of the present invention.

### DESCRIPTION OF THE PREFERRED EMBODIMENTS

Referring to the drawings, there is shown a preferred embodiment of a multi-layer composite system used in the method of the invention for repairing water-retaining structures. The system, which is generally denoted 10, is applied over an existing concrete structure which is in need of repair and in which, in the example illustrated, a crack is indicated at 12. The multi-layer composite system 10 basically comprises a bituminous sealing layer 16, an intermediate geosynthetic layer 18, and a hard concrete covering layer 20 which faces the water 22 retained by the concrete structure 12.

Considering the specific components of the system 10 in more detail, in a preferred embodiment of the system 10 illustrated in the drawings, the sealing layer 16 is disposed adjacent to the crack 12 and sealed against the existing concrete structure 12 to provide a water-tight seal against structure 12 and thus, in the example illustrated, to prevent water from flowing through crack 14. In the preferred embodiment illustrated, the liquid impervious layer 16 is manufactured from bitumen and is the conventional type used in the construction industry.

The geosynthetic layer 18 provides a mechanical bond between sealing layer 16 and protective layer 20 and, in the preferred embodiment, is made from a conventional geotextile used in construction.

The protective concrete covering 20 is bonded to the geotextile to form a hard durable protective coating for the bituminous sealing layer 16 so as to protect layer 16 from weathering.

Although the invention has been de scribed above in relation to preferred embodiments thereof Lit will be understood by those skilled in the art that variations and modifications can be effected in these preferred embodiments without departing from the scope and spirit of the invention.

### FIELD OF THE INVENTION

The present invention relates to a method for repairing concrete water-retaining structures, such as dams and canals, which employs a multi-layer composite system.

### BACKGROUND OF THE INVENTION

Water retaining structures such as dams, canals and the like often develop surface cracks from stresses caused by environmental conditions. These cracks must be repaired in a manner that prevents leakage and maintains the structural integrity of the original structure. The current method for repairing concrete water-retaining structures involves the mechanical bonding of a membrane to the existing structure. This method is expensive, prone to leaking, and does not perform well for long periods of time due to weathering. While the membrane initially seals the existing structure, the use of a mechanically bonded membrane does not provide a long-term solution to the problem of leakage.

### SUMMARY OF THE INVENTION

The invention is concerned with a method for repairing dams and other concrete structures, which employs a multiple layer barrier system that is inexpensive, easy to apply, and durable. The invention can be used for large scale lining of existing concrete structures such as dams and canals so as to prevent leaks over large areas. The invention is an improvement over traditional or conventional methods, which, as noted above, typically use mechanically bonded membranes, particularly with respect to durability of the concrete repairs.

In accordance with the invention a method for repairing water-retaining structures including an existing concrete outer surface which, in use, is in contact with the water to be retained, the method comprising:

applying water impervious bituminous sealing layer over a portion of the concrete surface to form a watertight sealing of the existing concrete layer;

applying a geosynthetic material to the water impervious bituminous sealing layer; and

applying a layer of concrete to the geosynthetic material such that said geosynthetic material provides a bond between said concrete layer and said bituminous sealing layer and said concrete layer provides a hard, durable outside protective layer for preventing weathering of said bituminous layer.

Further features and advantages of the present invention will be set forth in, or apparent from, the detailed description of preferred embodiments thereof which follows.

### BRIEF DESCRIPTION OF THE DRAWINGS

The single FIGURE in the drawings is a cross section view of a multi-layer composite barrier system used in the method of the present invention for repairing water-retaining structures, the barrier system being constructed in accordance with a preferred embodiment of the present invention.

### DESCRIPTION OF THE PREFERRED EMBODIMENTS

Referring to the drawings, there is shown a preferred embodiment of a multi-layer composite system used in the method of the invention for repairing water-retaining structures. The system, which is generally denoted 10, is applied over an existing concrete structure which is in need of repair and in which, in the example illustrated, a crack is indicated at 12. The multi-layer composite system 10 basically comprises a bituminous sealing layer 16, an intermediate geosynthetic layer 18, and a hard concrete covering layer 20 which faces the water 22 retained by the concrete structure 12.

Considering the specific components of the system 10 in more detail, in a preferred embodiment of the system 10 illustrated in the drawings, the sealing layer 16 is disposed adjacent to the crack 12 and sealed against the existing concrete structure 12 to provide a water-tight seal against structure 12 and thus, in the example illustrated, to prevent water from flowing through crack 14. In the preferred embodiment illustrated, the liquid impervious layer 16 is manufactured from bitumen and is the conventional type used in the construction industry.

The geosynthetic layer 18 provides a mechanical bond between sealing layer 16 and protective layer 20 and, in the preferred embodiment, is made from a conventional geotextile used in construction.

The protective concrete covering 20 is bonded to the geotextile to form a hard durable protective coating for the bituminous sealing layer 16 so as to protect layer 16 from weathering.

Although the invention has been described above in relation to preferred embodiments thereof, it will be understood by those skilled in the art that variations and modifications can be effected in these preferred embodiments without departing from the scope and spirit of the invention.

What is claimed is:

1. A method for repairing water retaining structures including an existing concrete outer surface which, in use, is in contact with the water to be retained, the method comprising:
applying a water impervious bituminous sealing layer over a portion of the existing concrete surface to form a water-tight sealing of the existing concrete surface;
applying a geosynthetic reinforcing material to the water impervious bituminous sealing layer; and
applying a layer of concrete to geosynthetic material such that said geosynthetic material provides a bond between said concrete layer and said bituminous sealing layer and such concrete layer provides a hard, durable exterior protective layer for preventing weathering of said bituminous sealing layer.
